(19) United States
(12) Patent Application Publication
(10) Pub. No.: US 2009/0302576 A1
(43) Pub. Date: Dec. 10, 2009

(54) Trailer Coupler with Sight Hole

(75) Inventor: Jeffrey A. Korman, Surprise, AZ (US)

Correspondence Address: TIFFANY & BOSCO;CAMELBACK ESPLANADE II, THIRD FLOOR, 2525 EAST CAMELBACK ROAD, PHOENIX, AZ, 85016, US

(73) Assignee: U-HAUL INTERNATIONAL, INC., Phoenix, AZ (US)

(21) Appl. No.: 12/136,713

(22) Filed: Jun. 10, 2008

(51) Int. Cl. B60D 1/06

(52) U.S. Cl. 280/511

(57) ABSTRACT

A coupler assembly for coupling a trailer to a towing vehicle hitch ball includes a coupler housing with an interior that defines a coupler socket adapted to receive a hitch ball. The coupler housing also includes a sight hole that communicates with the coupler socket and allows a user to see into the coupler socket to confirm proper engagement of the hitch ball and coupler.

### BACKGROUND

This invention relates to couplers. More particularly, it relates to a coupler mechanism having a sight hole that allows a user to visually determine when a hitch ball is properly positioned within the coupler socket.

Trailer couplers are known. Typically, trailer couplers consist of a conformally-shaped socket that is close-fitting around a spherical hitch ball. The coupler also has securing means by which separation of the coupler and hitch ball is blocked.

One problem that sometimes occurs when a coupler is placed over a hitch ball is that the hitch ball does not properly enter into the socket portion of the coupler, but rather, components within the coupler assembly come to rest on the top of the hitch ball rather than allowing the hitch ball to pass through to establish a conformal close fit between the hitch ball and coupler. When this occurs, the coupler installer can be unaware, and may engage the coupler securing means thinking it is functional, when in reality, it is not.

There is a need, therefore, for a coupler that addresses the foregoing problem. It is an object of the present invention to provide such an apparatus.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY OF THE INVENTION

To achieve the foregoing objects, and in accordance with the purposes of the invention as embodied and broadly described in this document, there is provided a coupler assembly for coupling a trailer to a towing vehicle hitch ball. The coupler assembly includes a coupler housing with an interior that defines a coupler socket adapted to receive a hitch ball. The coupler socket includes a bottom socket opening adapted to allow the insertion of the hitch ball into the coupler socket. The socket opening has a partially circumferential retaining rib. A ball clamp is disposed within the interior of the coupler housing and is movable toward and away from the coupler socket. The ball clamp has a clamping portion that cooperates with the socket opening retaining rib to retain the hitch ball within the coupler socket with the ball clamp is positioned toward the coupler socket in a hitch ball retention position. The coupler housing includes a sight hole that communicates with the coupler socket and allows a user to see into the coupler socket. In this configuration, the sight hole allows for visible inspection of the hitch ball in the coupler socket to confirm the proper engagement of the hitch ball and coupler.

### BRIEF DESCRIPTION OF THE DRAWINGS

The accompanying drawings, which are incorporated in and constitute a part of the specification, illustrate the presently preferred embodiments and methods of the invention and, together with the general description given above and the detailed description of the preferred embodiments and methods given below, serve to explain the principles of the invention.

FIG. 1A is a side sectional view of a prior ball clamp trailer coupler showing the hitch ball secured within the coupler socket with the ball clamp positioned in contact with the hitch ball in a retention position.

FIG. 1B is a side sectional view of the coupler of FIG. 1A showing the hitch ball within the coupler socket with the ball clamp positioned away from the hitch ball in a release position.

FIG. 1C is a side sectional view of the coupler of FIG. 1A, showing the ball clamp jammed into the socket by the hitch ball, resulting in the insecure engagement of the ball and socket.

FIG. 2 is a side sectional view of a coupler assembly in accordance with one embodiment of the present invention, showing the ball clamp in a retention position securing the hitch ball within the coupler socket.

FIG. 3 is a bottom perspective view of the housing of the coupler assembly of FIG. 2.

FIG. 4A is a front top perspective view of the coupler assembly of FIG. 2, showing the sight hole with no hitch ball engaged in the coupler socket.

FIG. 4B is a front top perspective view of the coupler assembly of FIG. 2, showing the hitch ball properly engaged in the coupler socket and visible through the sight hole.

### DESCRIPTION

Reference will now be made in more detail to presently preferred embodiments of the invention, as illustrated in the accompanying drawings. While the invention is described more fully with reference to these examples and drawings, the invention in its broader aspects is not limited to the specific details, representative devices, and illustrative examples shown and described. Rather, the description which follows is to be understood as a broad, teaching disclosure directed to persons of ordinary skill in the appropriate arts, and not as limiting upon the invention.

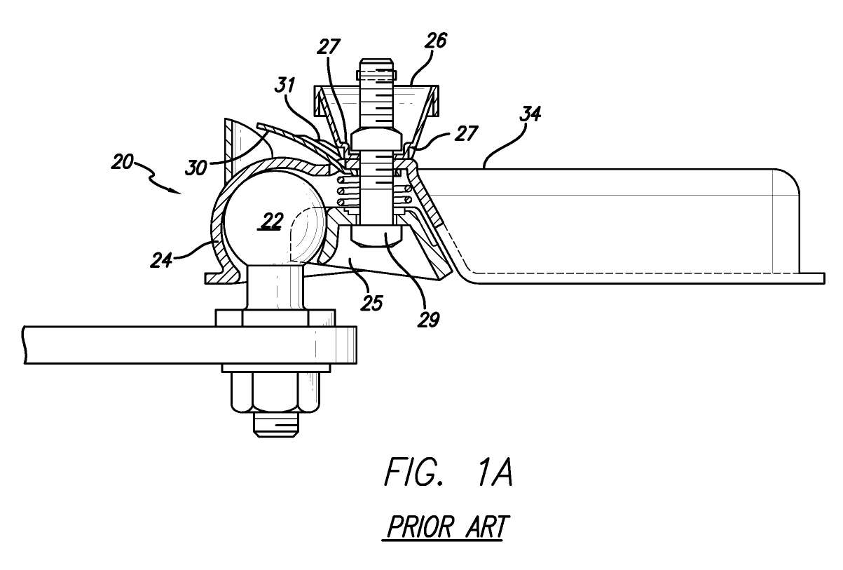

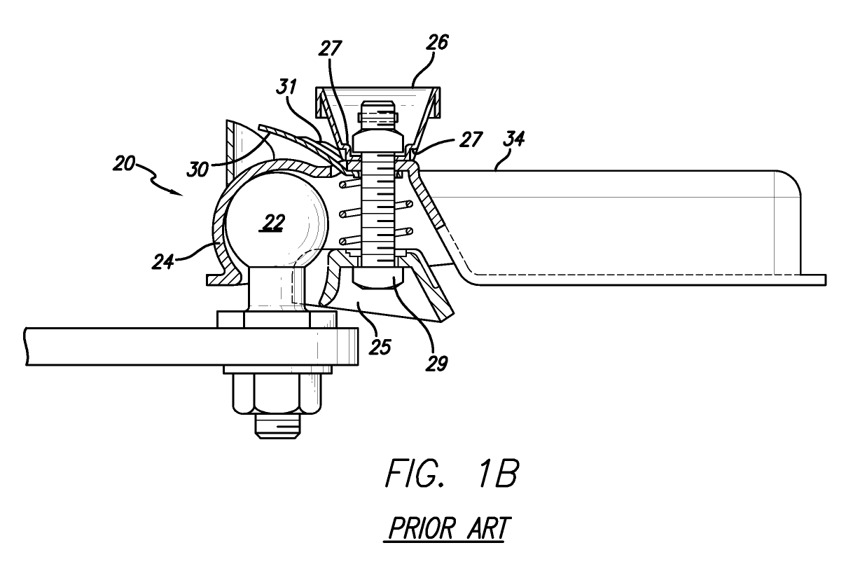

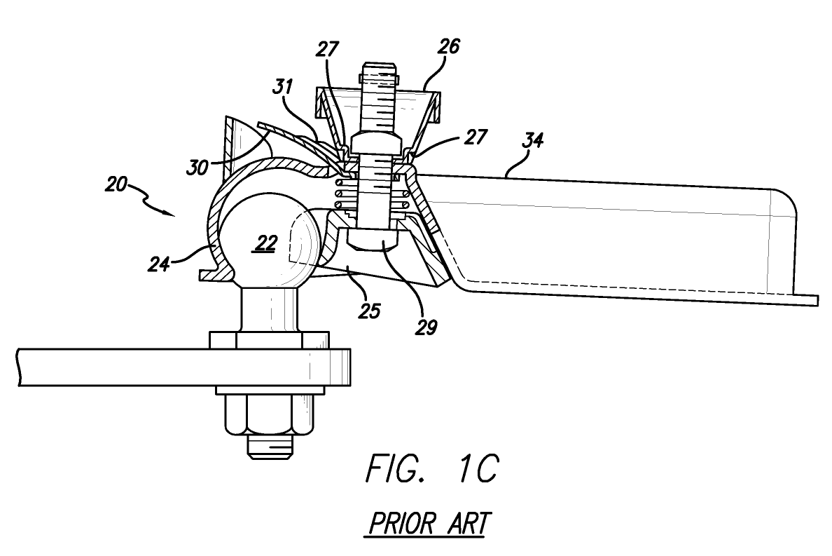

For purposes of explanation, and to further assist in the understanding of this invention, a brief description of the operation of a standard previously-known ball and socket coupler mechanism follows. Referring to FIGS. 1A-B, a hitch ball 22 is commonly affixed to the rear end of a tow vehicle, such as a truck or sport utility vehicle, utilizing a standard mounting device that can support the tongue weight of the trailered vehicle. Similarly, a coupler 20 is affixed, by commonly known techniques, e.g. welding, bolting, etc., to the frame of the vehicle that is to be towed, e.g. a trailer, thus forming an integrated frame unit. The coupler 20 has a housing 34 with a ball-shaped socket 24 for receiving the hitch ball 22 when the trailer is hitched to the tow vehicle. In operation the trailer coupler socket 24 is lowered, from an elevated height, relative to the hitch ball 22, onto the hitch ball 22 such that the socket 24 engulfs the hitch ball 22.

Still referring to FIGS. 1A-B, the ball and socket coupler further includes a user rotatable handwheel 26. The handwheel 26 is rotatably mounted upon a threaded member 29 such that rotation of the handwheel 26 draws or urges the threaded member 29 and a ball clamp 25 depending from the member 29 either toward or away from the hitch ball 22. The ball clamp 25 has a curved surface that conforms to the curved surface of the hitch ball 22. Upon rotation of the handwheel 26 in the appropriate direction (usually clockwise), the ball clamp 25 is drawn upward and toward the hitch ball 22, thereby decreasing the effective opening dimension of the socket 24 until the ball clamp 25 contacts the hitch ball 22 and secures it within the coupler socket 24. In this retention position, as shown in FIG. 1A, the ball clamp 25 cooperates with the socket 24 to prevent removal of the hitch ball 22 from the socket 24. Similarly, upon rotation of the handwheel 26 in the opposite direction (typically counterclockwise), the ball clamp 25 is moved downward and away from the hitch ball 22 to a release position, shown in FIG. 1B, which allows the hitch ball 22 to be released from the socket 24.

As shown in FIGS. 1A-B, a spring loaded retaining tab 30 is usually provided in ball and socket hitches in order to maintain the ball clamp 25 in the retention position. The tab 30 has a projection 31 that engages recesses 27 formed in the periphery of the handwheel 26. The tab 30 exerts a biasing force against one of the wheel recesses 27 to maintain the tab 30 in engagement with the handwheel 26. When engaged, the tab 30 prevents rotation of the handwheel 26, rotation being permitted only when the projection 31 of tab 30 is pivoted away from the recess 27 in the handwheel periphery.

During the rotation of the handwheel 26, the retaining tab 30 is continually depressed by the operator. The depression of the tab 30 disengages the tab projection 31 from the recesses 27 formed in the periphery of the handwheel 26. Upon positioning the handwheel 26 such that the coupler assembly 20 is in a coupled condition, the operator releases the tab 30 so that it engages one of the recesses 27 formed in the lower periphery of the handwheel 26, thus securing the handwheel 26. Minor additional rotation of the handwheel 26 may be required to properly align the tab 30 in one of the recesses 27. Proper alignment of the tab 30 in one of the recesses 27 helps prevent the handwheel 26 from becoming inadvertently loosened by vibrations, or other unexpected forces.

In the operation of the previously-known coupler illustrated in FIG. 1, the trailer/coupler assembly is first aligned over the hitch ball 22 with the ball clamp 25 in the release position. The trailer is then lowered so that the socket cavity 24 engulfs the hitch ball 22, as shown in FIG. 1B. After the hitch ball 22 is positioned in the socket cavity 24, the handwheel 26 is then rotated to move the ball clamp 25 into the retention position shown in FIG. 1A. In this position, the ball clamp 25 reduces the effective opening of the coupler socket 24 so that the hitch ball 22 can no longer be readily retracted from the coupler socket 24 and the coupler assembly 20 is securely coupled.

As shown in FIG. 1C, during installation of the hitch ball 22 into the coupler socket 24, the hitch ball 22 can strike the ball clamp 25 from below and jam the ball clamp 25 upward into the coupler socket 24 and in an insecure relationship with the hitch ball 22, which can result in unwanted separation of the hitch ball 22 from the coupler socket 24.

Having described the operational characteristics of a typical ball and socket coupler mechanism, the features of an improved coupler assembly according to the present invention will now be described. In accordance with the present invention, disposed within the coupler socket 24 is a sight hole 40. The sight hole 40 gives the user simple and effective visual means by which full entry of the hitch ball 22 into the coupler socket 24 can be confirmed.

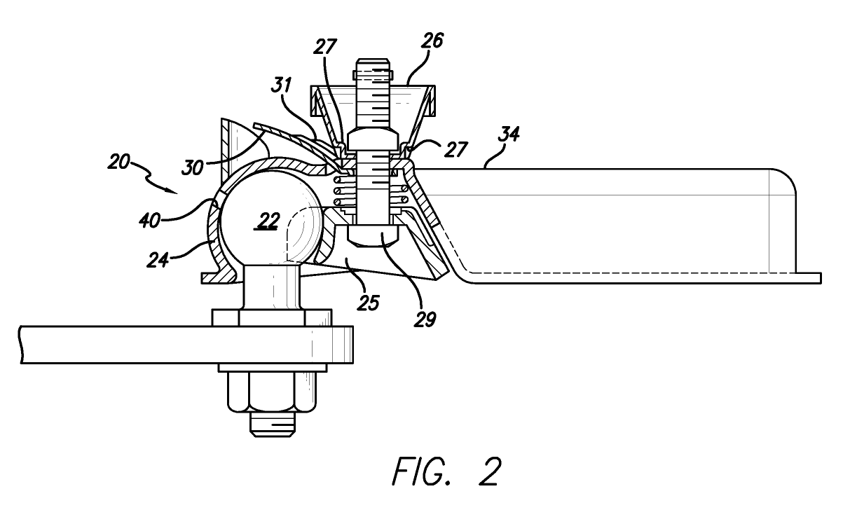

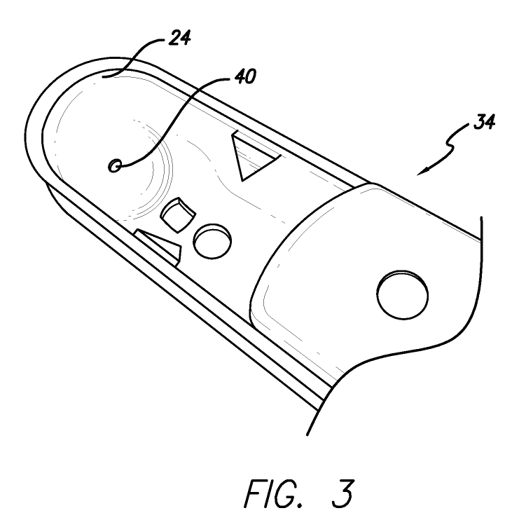

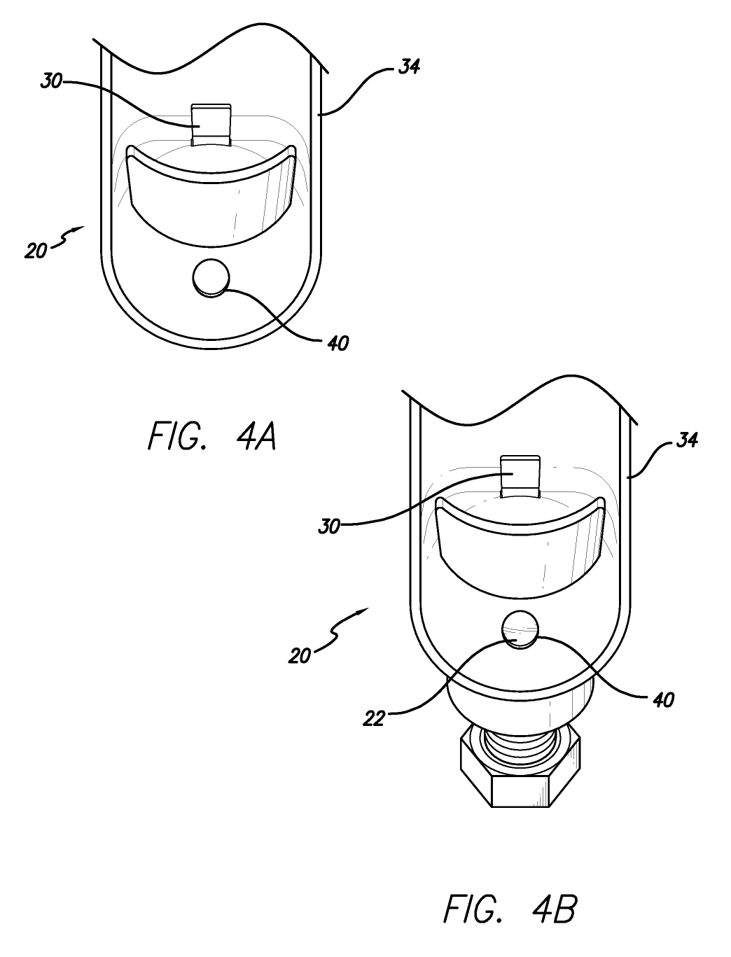

FIGS. 2-4 depict a coupler assembly in accordance with a presently preferred embodiment of the invention. In one preferred embodiment, the sight hole 40 is located on the front upper portion of the coupler housing, as best shown in FIGS. 4A and 4B. Upon reading this disclosure, it will be understood that the sight hole 40 can be located in the coupler housing in any suitable location for viewing the interior of the coupler socket 24. This location also can be, for example, the top or the side of the coupler housing around the coupler socket. The sight hole 40 can be formed in the coupler housing by any suitable means, including drilling, punching or stamping.

In the operation, the coupler 20 is first aligned over the hitch ball 22 which is attached to the vehicle. The trailer is then lowered so that the coupler comes into contact with the hitch ball 22. If the hitch ball 22 enters fully into the coupler socket 24 such that the socket cavity 24 engulfs the hitch ball 22 therein (see FIG. 2), the user will be able to observe this through the sight hole 40, as shown in FIG. 4B. If, on the other hand, the hitch ball 22 contacts the ball clamp 25 from below and the ball clamp 25 prevents the hitch ball 22 from fully entering the coupler socket 24 (see FIG. 1C), the user will be able to observe through the sight hole 40 that the hitch ball 22 is not properly positioned within the coupler socket 24.

After the user confirms via the sight hole 40 that the hitching ball 22 is properly positioned in the socket cavity 24, the handwheel 26 is then rotated, as previously described, thereby drawing the ball clamp 25 upward and forward toward the hitch ball 22 until the ball clamp reaches the retention position shown in FIG. 2. In this position, the ball clamp 25 reduces the effective opening of the coupler socket 24 and contacts the hitch ball 22 so that it cannot be readily retracted from the coupler socket 24. The operator then aligns the tab projection 31 in one of the recesses 27 and releases the tab 30 to secure the handwheel 26 as previously described.

Upon reading this disclosure, those skilled in the art will appreciate that various changes and modifications may be made to the preferred embodiments of the invention and that such changes and modifications may be made without departing from the spirit of the invention. Therefore, the invention in its broader aspects is not limited to the specific details, representative devices, and illustrative examples shown and described. Accordingly, departures may be made from such details without departing from the spirit or scope of the general inventive concept.

What is claimed is:

1. A coupler assembly for coupling a trailer to a towing vehicle hitch ball, the coupler assembly comprising:
a coupler housing having an interior that defines a coupler socket adapted to receive a hitch ball, wherein the coupler socket includes a bottom socket opening that allows the insertion of the hitch ball into the coupler socket and that has a partially circumferential retaining rib; and
a ball clamp movably coupled to the coupler housing and movable within the housing toward and away from the coupler socket, wherein the ball clamp has a clamping portion that cooperates with the socket opening retaining rib to retain the hitch ball within the coupler socket when the ball clamp is positioned toward the coupler socket in a hitch ball retention position;
wherein the coupler housing includes a sight hold passage that extends from the exterior of the coupler housing to the coupler socket and allows a user to see into the coupler socket.

2. The coupler assembly of claim 1 wherein the sight hole is located on the upper portion of the coupler housing.

3. The coupler assembly of claim 1 wherein the sight hole is located on a side of the coupler housing.

4. A method for manufacturing a coupler housing for coupling a trailer to a towing vehicle hitch ball, the method comprising:
providing a coupler housing having an interior that defines a coupler socket adapted to receive a hitch ball,
wherein the coupler socket includes a bottom socket opening that allows the insertion of the hitch ball into the coupler socket, and
wherein the coupler housing is adapted to accommodate a ball clamp movably coupled to the coupler housing and movable within the housing toward and away from the coupler socket; and
forming a sight hole in the coupler housing, wherein the sight hole provides a line of sight from the exterior of the coupler housing into the coupler socket.

5. The coupler assembly of claim 4 wherein the sight hole is formed in the upper portion of the coupler housing.

6. The coupler assembly of claim 4 wherein the sight hole is formed in a side of the coupler housing.

7. A method for coupling a trailer to a towing vehicle hitch ball, the method comprising:
providing a coupler assembly including:
a coupler housing having an interior that defines a coupler socket adapted to receive a hitch ball, wherein the coupler socket includes a bottom socket opening that allows the insertion of the hitch ball into the coupler socket and that has a partially circumferential retaining rib; and
a ball clamp movably coupled to the coupler housing and movable within the housing toward and away from the coupler socket, wherein the ball clamp has a clamping portion that cooperates with the socket opening retaining rib to retain the hitch ball within the coupler socket when the ball clamp is positioned toward the coupler socket in a hitch ball retention position;
wherein the coupler housing includes a sight hole passage that extends from the exterior of the coupler housing to the coupler socket and allows a user to see into the coupler socket;
positioning the coupler socket over the hitch ball;
viewing the interior of the coupler socket through the sight hole to determine whether the hitch ball is properly positioned within the coupler socket; and
moving the ball clamp into the hitch ball retention position.

8. The coupler assembly of claim 7 wherein the sight hole is located on the upper portion of the coupler housing.

9. The coupler assembly of claim 7 wherein the sight hole is located on a side of the coupler housing.
